(19) United States
(12) Patent Application Publication
(10) Pub. No.: US 2017/0269941 A1
(43) Pub. Date: Sep. 21, 2017

(54) METHOD FOR FORCIBLY RESETTING MICROCONTROLLER

(71) Applicant: ZIPPY TECHNOLOGY CORP., New Taipei City (TW)

(72) Inventors: Tsun-Te SHIH, New Taipei City (TW); Yu-Yuan CHANG, New Taipei City (TW); Kuang-Lung SHIH, New Taipei City (TW); Wen-Lung LI, New Taipei City (TW)

(21) Appl. No.: 15/147,645

(22) Filed: May 5, 2016

(30) Foreign Application Priority Data
Mar. 16, 2016 (TW) 105108052

(51) Int. Cl. G06F 9/44; G06F 11/07; G06F 1/28

(52) U.S. Cl. CPC G06F 9/4403; G06F 1/28; G06F 11/0751; G06F 11/0721

(57) ABSTRACT

A method for forcibly resetting a microcontroller is provided. A switching module is provided to power a microcontroller. The switching module detects through the control pin whether a notification port of a load connected to the control pin changes its potential level in response to a communication error between the load and the microcontroller detected by the load. When the switching module learns the change in the potential level of the notification pin, a powering status of the switching module is switched to stop powering the microcontroller to cause the microcontroller to stop operating. It is detected through the control pin whether the load again changes the potential level of the notification port in response to the microcontroller having stopped operating. When the change is detected, the powering status of the switching module is switched to again power and reactivate the microcontroller.

### FIELD OF THE INVENTION

The present invention relates to a method for forcibly resetting a microcontroller, and particularly to a method for forcibly resetting a microcontroller through an external switching module.

### BACKGROUND OF THE INVENTION

As information equipments continue to evolve, in order to ensure these information equipments obtain stable power, many industrialist have proposed power supplies with a communication function. Such power supply is capable of communicating with a load to provide at least one operating parameter of the power supply in operation. The load may then learn an operating status of the power supply according to the operating parameter. More specifically, the load is an information equipment, in which a baseboard management controller (BMC) communicates with the power supply through a power management bus (PMbus) to obtain the operating status of the power supply.

However, in actual operations, the PMbus is prone to abnormalities due to external factors, such that the BMC may fail to reliably obtain the operating status of the power supply, hence disfavoring the operations of the information equipment.

In view of the above, there are developers that raised technical solutions for reactivating a microcontroller used for communication in the power supply by using software. For example, these conventional solutions include disclosures of the Taiwan Patent Publication No. 201007444 and the Taiwan Patent No. 1305308.

In the above disclosures providing technical solutions for self-activating the microcontroller by software, the microcontroller is merely reactivated, and electrical signals in the microcontroller are not in fact cleared. Thus, after the microcontroller is reactivated, the abnormality in the PMbus still reside to cause the software to consistently reactivate the microcontroller, hence undesirably affecting the life cycle of the power supply.

### SUMMARY OF THE INVENTION

The primary object of the present invention is to solve the issue that a microcontroller cannot be reliably reset by software.

To achieve the above object, the present invention provides a method for forcibly resetting a microcontroller. The method includes following steps.

In step 1, a switching module is provided, the switching module is caused to obtain an operating power from a power source to power a microcontroller, and a control pin of the switching module is connected a notification port of a load.

In step 2, the microcontroller is activated and caused to communicate with the load, and the switching module detects through the control pin whether the load changes a potential level of the notification port in response to a communication error between the load and the microcontroller detected by the load. The switching module is caused to continue providing the microcontroller with the operating power if the potential level of the notification port is not changed, or else the method proceeds to a next step.

In step 3, the change in the potential level of the notification port is received, and a powering status of the switching module is switched to stop providing the microcontroller with the operating power to cause the microcontroller to stop operating.

In step 4, it is detected through the control pin whether the load again changes the potential level of the notification port in response to the microcontroller having stopped operating, and the when it is detected that the potential level of the notification port is changed, the powering status of the switching module is switched to again provide the microcontroller with the operating power to cause the microcontroller to reactivate.

In one embodiment, step 2 further comprises a sub-step of causing the load to enter an communication error detection mode, and changing the potential level of notification port when the load discovers the communication error in the communication error detection mode.

In one embodiment, when the load is in the communication error detection mode and detects whether the communication between the load and the microcontroller is normal or the microcontroller is turned off, the load causes the potential level of the notification port to be at a low potential level.

In one embodiment, the switching module includes a ground pin, a power connecting pin connected to the power source, a power supplying pin connected to the microcontroller, and a switching unit that determines whether to connect the power supplying pin to the ground pin or the power connecting pin according to the detection result of the control pin.

In one embodiment, step 4 further includes a sub-step of setting the load wait for a resetting period before detecting whether the microcontroller stops operating to again change the potential level of the notification port.

In one embodiment, the microcontroller and the switching module are built in a power supply, and the microcontroller communicates with the load through a power management bus (PMbus).

In one embodiment, the power source is a standby power output loop of the power supply, and the operating power is a standby power that the standby power output loop provides to the switching module.

The solution of the present invention provides features below compared to the prior art. Through the switching module of the present invention, the potential level of all components of the microcontroller is completely disconnected and cleared during the process of the resetting the microcontroller to reliably achieve the object of resetting, thereby solving the issue that the microcontroller cannot be reliably reset in the prior art.

### BRIEF DESCRIPTION OF THE DRAWINGS

FIG. 1 is a schematic diagram of components according to an embodiment of the present invention;

FIG. 2 is a schematic diagram of components according to an embodiment of the present invention applied to a power supply;

FIG. 3 is a flowchart of a method according to an embodiment of the present invention;

FIG. 4 is a first implementation schematic diagram according to an embodiment of the present invention;

FIG. 5 is a second implementation diagram according to an embodiment of the present invention; and

FIG. 6 is a flowchart of a method according to another embodiment of the present invention.

### DETAILED DESCRIPTION OF THE PREFERRED EMBODIMENTS

Details and technical contents of the present invention are given with the accompanying drawings below.

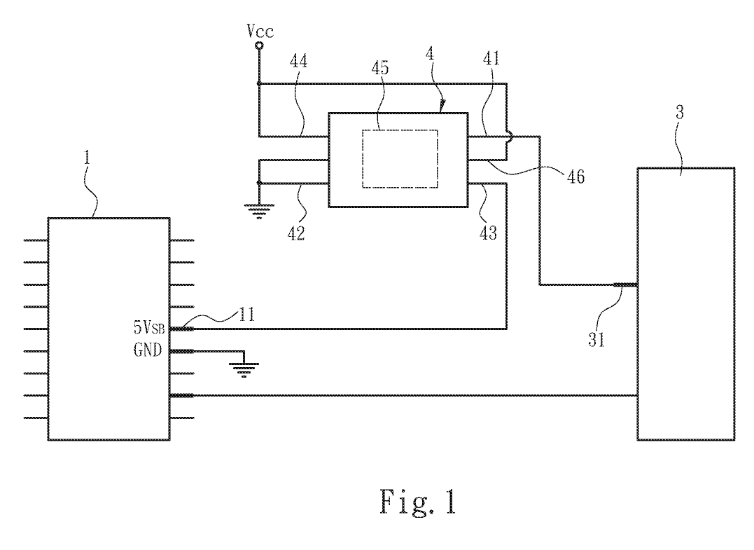

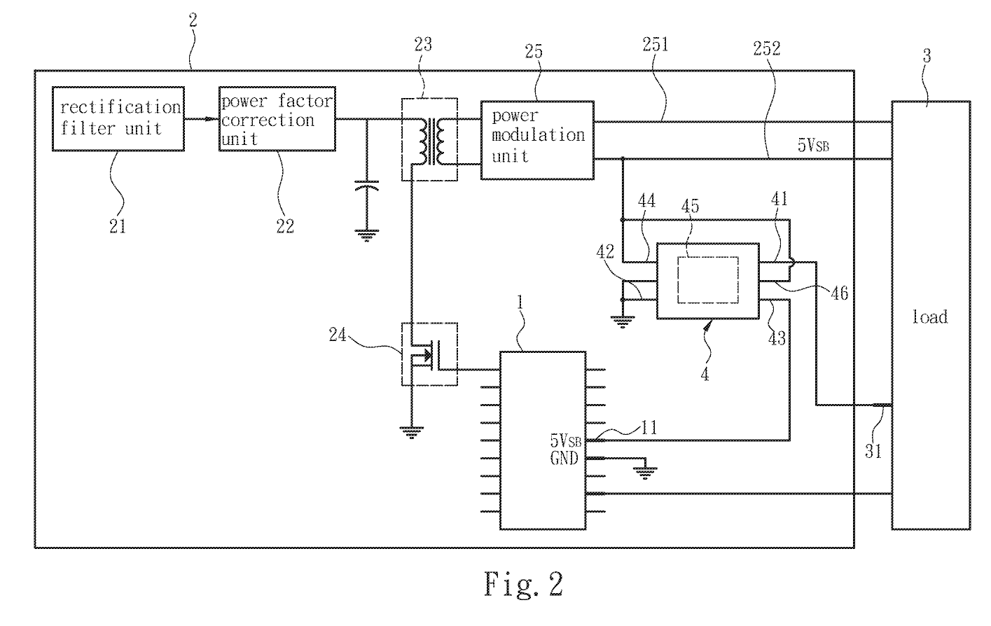

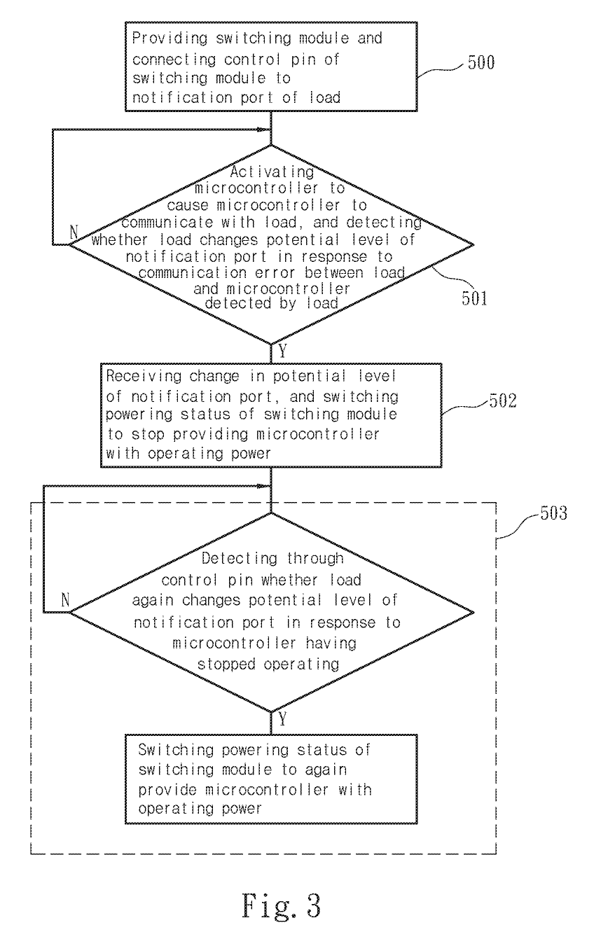

Referring to FIG. 1 and FIG. 2, the present invention provides a method for forcibly resetting a microcontroller. The microcontroller 1 is built in an electronic apparatus. For example, the microcontroller 1 is a microchip, and is configured to operate and perform at least one function process. To better illustrate implementation details of the present invention, a non-limiting embodiment of the microcontroller 1 built in a power supply 2 is given as an example and is not to be construed as a limitation to the present invention. The power supply 2 at least includes a rectification filter unit 21 connected to an external power supply end, a power factor correction unit 22 connected to the rectification filter unit 21, a transformer 23 connected to the power factor correction unit 22, a switch element 24 connected to the transformer 23, and a power modulation unit 25 connected to the transformer 23. The power modulation unit 25 is connected to a load 3 and powers the load 3. In one embodiment, the load 3 is a motherboard or an information equipment, and the power modulation unit 25 is designed to convert the power transmitted at the secondary side of the transformer 23 to various types of power required by Advanced Technology eXtended (ATX) motherboard specifications. The power modulation unit 25 includes a main operating power output loop 251 and a standby power output loop 252. Further, the main operating power output loop 251 outputs 12V, 3.3V and 5V powers to the load 3, and the standby power output loop 252 outputs a standby power 5VSB to the load 3. Referring to FIG. 3, the method according to an embodiment of the present invention includes following steps.

In step 1 (500), a switching module 4 is provided, the switching module 4 is caused to obtain an operating power from a power source to power the microcontroller 1, and a control pin 41 of the switching module 4 is connected to a notification port 31 of the load 3.

In step 2 (501), the microcontroller 1 is activated to cause the microcontroller 1 to communicate with the load 3, and the switching module 4 detects through the control pin 41 whether the load 3 changes the potential level of the notification port 31 in response a communication error between the load 3 and the microcontroller 1 detected by the load 3. If the potential level of the notification port 31 is not changed, the switching module 4 is caused to continue providing the microcontroller 1 with the operating power, or else the method proceeds to a next step.

In step 3 (502), the change in the potential level of the notification port 31 is received, and the powering status of the switching module 4 is switched to stop providing the microcontroller 1 with the operating power to cause the microcontroller 1 to stop operating.

In step 4 (503), it is detected through the control pin 41 whether the load 3 again changes the potential level of the notification port 31 in response to the microcontroller 1 having stopped operating, and when the change in the potential level of the notification port 31 is detected, the powering status of the switching module 4 is switched to again provide the microcontroller 1 with the operating power to cause the microcontroller 1 to reactivate.

The microcontroller 1 and the switching module 4 of the present invention are built in the power supply 2. The microcontroller 1 includes at least one power input pin 11, obtains power for operations through the power input pin 11 and performs power management operations after being activated. For example, the so-called power management operations include detecting the operating status of the power supply 2 to output at least one operating parameter. In one embodiment, the microcontroller 1 may also output a pulse width modulation (PWM) signal to the switch element 24. Further, the microcontroller 1 communicates with the load 3 after being activated to transmit a message to the load 3 or to receive a message from the load 3. In this embodiment, the microcontroller 1 communicates with the load 3 according to PMbus communication specifications.

The switching module 4 of the present invention may be implemented by a microchip, and at least includes the control pin 41 connected to the notification port 31. The control pin 41 is directly electrically connected to the notification port 31 to obtain the change in the potential level of the notification port 31. In addition to the control pin 41, the switching module 4 further includes a ground pin 42, a power supplying pin 43 connected to the power input pin 11 of the microcontroller 1, a power connecting pin 44, and a switching unit 45 that determines to connect the power supplying pin 43 to the ground pin 42 or the power connecting pin 44 according to the detection result of the control pin 41. The connection status of the switching unit 45 determines the powering status of the switching module 4. More specifically, the switching module 4 of the present invention has the powering status and a power suspended status. In the powering status, the power supplying pin 43 is connected to the power connecting pin 44 to output the operating to the microcontroller 1. In the power suspended status, the power supplying pin 43 is connected to the ground pin 42 such that the operating power cannot be outputted to the microcontroller 1. In the embodiment, the power connecting pin 44 of the switching module 4 is connected to the standby power output loop 252 of the power supply 2, in a way that the standby power output loop 252 is considered as the power source, and the standby power 5VSB that the standby power output loop 252 provides to the switching module 4 serves as the operating power. The switching module 4 further includes a power pin 46 connected to the standby power output loop 252. The power pin 46 receives the standby power 5VSB to cause the switching module 4 to activate and operate using the standby power 5VSB.

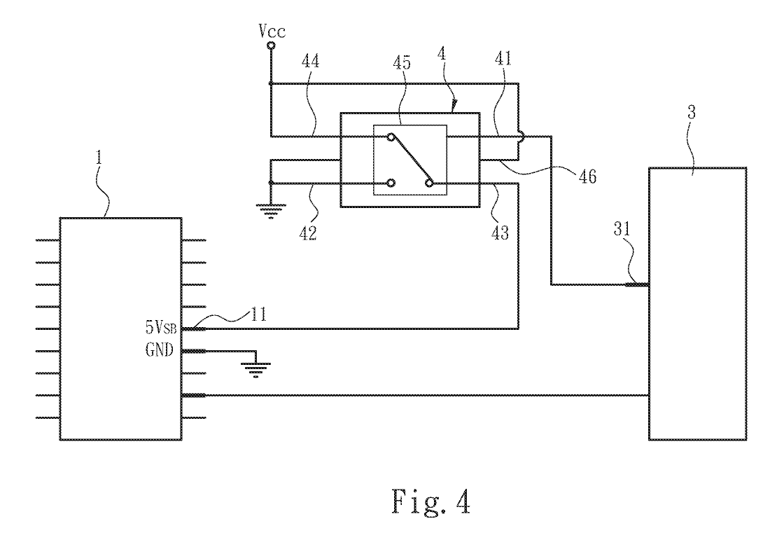

Referring to FIG. 4, during the process of step 501, after the microcontroller 1 is activated, the microcontroller 1 continues communicating with the load 3. At this point, the switching module 4 of the present invention detects through the control pin 41 whether the notification port 31 changes the potential level of the notification port 31 in response to a communication error between the load 3 and the microcontroller 1 detected by the load 3. More specifically, when the microcontroller 1 and the load 3 communicate with each other functionally, the potential level of the notification port 31 is normally set to a low potential level and stays unchanged, and the switching module 4 is normally in the powering status to continue providing the microcontroller 1 with the operating power for the microcontroller 1 to continue operating. However, when the microcontroller 1 cannot functionally communicate with the load 3 due to external factors, the load 3 first requests the microcontroller 1 to reactivate for several times. If the communication error persists, the load 3 changes the potential level of the notification port 31 to cause the potential level of the notification port 31 to change from a low level to a high level, such that the control pin 41 may detect the change in the notification port 31 and the method may proceed to step 502.

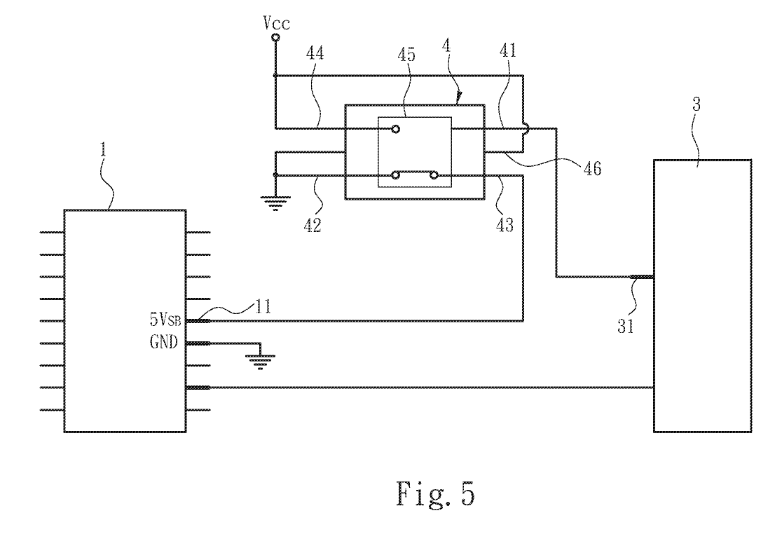

Referring to FIG. 5, during the process of step 502, when the control pin 41 receives the change in the potential level of the notification port 31, the powering status of the switching module 4 is switched. Thus, according to the change received by the control pin 41, the switching unit 45 disconnects the connection between the power connecting pin 44 and the power supplying pin 43, and connects the power supplying pin 43 to the ground pin 42 to enter the power suspended status. At this point, the power supplying pin 43 cannot provide the microcontroller 1 with the operating power, such that the microcontroller 1 cannot obtain the operating power and stops operating to become completely turned off. The method then proceeds to step 503, in which it is detected through the control pin 41 whether the load 3 again changes the potential level of the notification port 31 in response to the microcontroller 1 having stopped operating. More specifically, it is known from the above description that, in the present invention, when a communication error occurs between the microcontroller 1 and the load 3, the load 3 sets the potential level of the notification port 31 to a high potential level to cause the switching module 4 to enter the power suspended status. As such, the microcontroller 1 entirely loses the operating power and becomes completely turned off. The load 3 then later again changes the potential level of the notification port 31 in response to the microcontroller 1 having stopped operating to cause the potential level of the notification port 31 to change from a high potential level to a low potential level. Meanwhile, the control pin 41 detects whether the load 3 again changes the potential level of the notification port 31 in response to the microcontroller 1 having stopped operating. When the control pin 41 detects the change at the notification port 31, the switching module 4 switches from the power suspended status to the powering status to again provide the microcontroller 1 with the operating power to cause the microcontroller 1 to reactivate. Thus, with the above solution of the present invention, the microcontroller 1 can be completely turned off, thereby solving the issue that the microcontroller 1 cannot be reliably reset by program software.

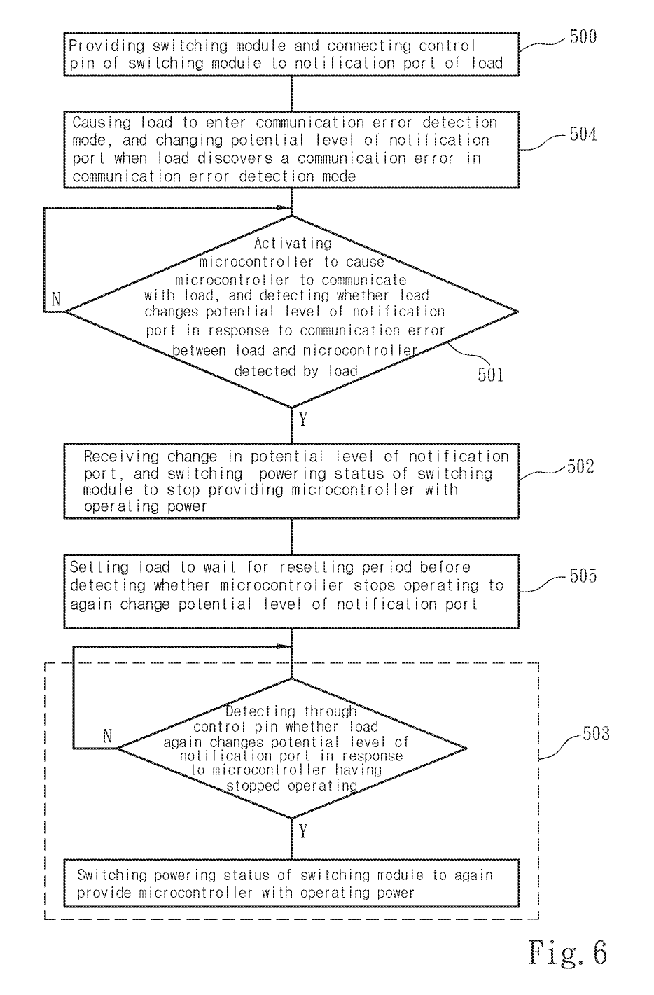

Referring to FIG. 6, in one embodiment, step 501 of the method of the present invention further includes sub-step 504. In sub-step 504, the load 3 is caused to enter a communication error detection mode, and the potential level of the notification port 31 is changed when the load 3 discovers a communication error in the communication error detection mode. The load 3 may enter the communication error detection mode by executing an engineering program configured in the load 3 in advance. The communication error detection mode is primarily for determining whether a communication error occurs between the microcontroller 1 and the load 3. If so, the potential level of the notification port 31 is changed in order to proceed to subsequent steps. Associated details can be referred from the foregoing description, and shall be omitted herein.

Further, to ensure that the microcontroller 1 does reactivate, step 504 of the method of the present invention further includes sub-step 505. In sub-step 505, the load 3 is set wait for a resetting period before detecting whether the microcontroller 1 stops operating to again change the potential level of the notification port 31.

What is claimed is:

1. A method for forcibly resetting a microcontroller, comprising steps of:
step 1: providing a switching module, causing the switching module to obtain an operating power from a power source to power a microcontroller, and connecting a control pin of the switching module to a notification port of a load;
step 2: activating the microcontroller to cause the microcontroller to communicate with the load, detecting through the control pin by the switching module whether the load changes a potential level of the notification port in response a communication error between the load and the microcontroller detected by the load, and causing the switch module to continue providing the microcontroller with the operating power when the potential level of the notification port is not changed or performing a next step when the potential level of the notification port is changed;
step 3: receiving the change in the potential level of the notification port, switching a powering status of the switching module to stop providing the microcontroller with the operating power to cause the microcontroller to stop operating; and
step 4: detecting through the control pin whether the load again changes the potential level of the notification port in response to the microcontroller having stopping operating, and switching the powering status of the switching module to again provide the microcontroller with the operating power when the change in the potential level of the notification port is detected to reactivate the microcontroller.

2. The method for forcibly resetting a microcontroller of claim 1, wherein step 2 further comprises a sub-step of:
causing the load to enter a communication error detection mode, and changing the potential level of the notification port when the load discovers a communication error in the communication error detection mode.

3. The method for forcibly resetting a microcontroller of claim 2, wherein in the communication error detection mode, the load causes the potential level of the notification port to stay at a low level when detecting whether the microcontroller is normal or is turned off.

4. The method for forcibly resetting a microcontroller of claim 1, wherein the switching module comprises a ground pin, a power connecting pin connected to the power source, a power supplying pin connected to the microcontroller, and a switching unit that determines whether to connect the power supplying pin or the ground pin according to a detection result of the control pin.

5. The method for forcibly resetting a microcontroller of claim 2, wherein the switching module comprises a ground pin, a power connecting pin connected to the power source, a power supplying pin connected to the microcontroller, and a switching unit that determines whether to connect the power supplying pin or the ground pin according to a detection result of the control pin.

6. The method for forcibly resetting a microcontroller of claim 1, wherein step 4 comprises a sub-step of:
setting the load to wait for a resetting period before detecting whether the microcontroller stops operating to again change the potential level of the notification port.

7. The method for forcibly resetting a microcontroller of claim 2, wherein step 4 further comprises a sub-step of:
setting the load to wait for a resetting period before detecting whether the microcontroller stops operating to again change the potential level of the notification port.

8. The method for forcibly resetting a microcontroller of claim 1, wherein the microcontroller and the load are built in a power supply, and the microcontroller communicates with the load according to a power management bus (PMbus).

9. The method for forcibly resetting a microcontroller of claim 8, wherein the power source is a standby power output loop of the power supply, and the operating power is a standby power that the standby power output loop provides to the switching module.

10. The method for forcibly resetting a microcontroller of claim 3, wherein the microcontroller and the load are built in a power supply, and the microcontroller communicates with the load according to a power management bus (PMbus).

11. The method for forcibly resetting a microcontroller of claim 10, wherein the power source is a standby power output loop of the power supply, and the operating power is a standby power that the standby power output loop provides to the switching module.
